(19) United States
(12) Patent Application Publication
(10) Pub. No.: US 2025/0220195 A1
(43) Pub. Date: Jul. 3, 2025

(54) VIDEO CODING METHOD AND APPARATUS, DEVICE, AND STORAGE MEDIUM

(71) Applicant: Tencent Technology (Shenzhen) Company Limited, Shenzhen (CN)

(72) Inventor: Jia Zhang, Shenzhen (CN)

(21) Appl. No.: 19/087,294

(22) Filed: Mar. 21, 2025

Related U.S. Application Data
(63) Continuation of application No. PCT/CN2024/074673, filed on Jan. 30, 2024.

(30) Foreign Application Priority Data
Mar. 3, 2023 (CN) 202310195983.8

(51) Int. Cl. H04N 19/14; H04N 19/172

(52) U.S. Cl. CPC H04N 19/14; H04N 19/172

(57) ABSTRACT

Embodiments of this application provide a video coding method performed by a computer device. The method includes: acquiring a target video frame and coding information of the target video frame, the target video frame including M first coding units (CUs), and the coding information including locations of the M first CUs in the target video frame and prediction modes of the M first CUs; acquiring a to-be-coded second CU in the target video frame; determining a prediction mode of the second CU according to the prediction mode of a first CU that is in the M first CUs and that has an overlapping region with the second CU; and coding the second CU according to the prediction mode of the second CU, to obtain bitstream data corresponding to the target video frame under a second coding/decoding standard.

### CROSS-REFERENCE TO RELATED APPLICATIONS

This application is a continuation application of PCT Patent Application No. PCT/CN2024/074673, entitled “VIDEO CODING METHOD AND APPARATUS, DEVICE, AND STORAGE MEDIUM” filed on Jan. 30, 2024, which claims priority to Chinese Patent Application No. 2023101959838, entitled “VIDEO CODING METHOD AND APPARATUS, DEVICE, AND STORAGE MEDIUM” filed with the China National Intellectual Property Administration on Mar. 3, 2023, all of which are incorporated herein by reference in their entirety.

### FIELD OF THE TECHNOLOGY

This application relates to the field of computer technologies, and in particular, to a video coding method and apparatus, a device, and a storage medium.

### BACKGROUND OF THE DISCLOSURE

With the progress of science and technology research, video consumers have continuously increased requirements for video quality (such as definition). To support transmission of a high-quality video, video coding/decoding standards also continuously update. Research has found that, to convert first bitstream data coded according to a first coding/decoding standard (an old coding/decoding standard) of a video into second bitstream data coded according to a second coding/decoding standard (a new coding/decoding standard), the first bitstream data needs to be decoded first, and then a video obtained through decoding needs to be recoded according to the second coding/decoding standard. In the process of recoding the video obtained through decoding according to the second coding/decoding standard, coding efficiency of coding blocks in a video frame in different prediction modes usually needs to be compared, to determine a prediction mode of the coding block, which leads to relatively low coding efficiency of the video frame.

### SUMMARY

Embodiments of this application provide a video coding method and apparatus, a device, a computer-readable storage medium, to improve coding efficiency of a video frame.

In an aspect, the embodiments of this application provide a video coding method, which is performed by a computer device, and the method includes:
acquiring a target video frame and coding information of the target video frame, the target video frame comprising M first coding units (CUs) according to a first coding/decoding standard, and the coding information comprising locations of the M first CUs in the target video frame and prediction modes of the M first CUs under the first coding/decoding standard, and M being a positive integer;
acquiring a to-be-coded second CU in the target video frame according to a second coding/decoding standard, and the second coding/decoding standard being different from the first coding/decoding standard;
determining, according to the locations of the M first CUs in the target video frame and a location of the second CU in the target video frame, a first CU that has an overlapping region with the second CU from the M first CUs;
determining a prediction mode of the second CU according to the prediction mode of the first CU that has the overlapping region with the second CU; and
coding the second CU according to the prediction mode of the second CU, to obtain bitstream data corresponding to the target video frame under the second coding/decoding standard.

In an aspect, the embodiments of this application provide a video coding apparatus, which includes:
an acquisition unit, configured to acquire a target video frame and coding information of the target video frame, the target video frame comprising M first coding units (CUs) according to a first coding/decoding standard, and the coding information comprising locations of the M first CUs in the target video frame and prediction modes of the M first CUs under the first coding/decoding standard, and M being a positive integer;
acquire a to-be-coded second CU in the target video frame according to a second coding/decoding standard, and the second coding/decoding standard being different from the first coding/decoding standard; and
a processing unit, configured to determine, according to the locations of the M first CUs in the target video frame and a location of the second CU in the target video frame, a first CU that has an overlapping region with the second CU;
determine a prediction mode of the second CU according to the prediction mode of the first CU that has the overlapping region with the second CU; and
code the second CU according to the prediction mode of the second CU, to obtain bitstream data corresponding to the target video frame under the second coding/decoding standard.

Correspondingly, this application provides a computer device, which includes:
a memory, having a computer program stored therein; and
a processor, configured to load the computer program to implement the foregoing video coding method.

Correspondingly, this application provides a non-transitory computer-readable storage medium, which stores a computer program. A processor loads the computer program to perform the foregoing video coding method.

Correspondingly, this application provides a computer program product or a computer program, which includes computer instructions. The computer instructions are stored in a computer-readable storage medium. A processor of a computer device reads the computer instructions from the computer-readable storage medium and executes the computer instructions, to cause the computer device to perform the foregoing video coding method.

According to the embodiments of this application, the target video frame and the coding information of the target video frame are acquired, the target video frame includes the M first CUs, and the coding information includes the locations of the M first CUs in the target video frame and the prediction modes of the M first CUs. The to-be-coded second CU in the target video frame is acquired. The prediction mode of the second CU is determined according to the prediction mode of the first CU that is in the M first CUs and that has the overlapping region with the second CU, whereby the process of determining the prediction mode of the second CU can be simplified. The second CU is coded according to the prediction mode determined for the second CU, to obtain the bitstream data corresponding to the target video frame under the second coding/decoding standard. By the method for rapidly predicting the prediction mode of the second CU according to the prediction mode of the first CU, a coding/decoding speed of the target video frame under the second coding/decoding standard is accelerated, whereby coding efficiency of the target video frame is improved.

### BRIEF DESCRIPTION OF THE DRAWINGS

FIG. 1 is a schematic diagram of a scene of a video coding solution according to an embodiment of this application.

FIG. 2 is a flowchart of a video coding method according to an embodiment of this application.

FIG. 3A is a schematic diagram of a basic partitioning mode according to an embodiment of this application.

FIG. 3B is a schematic diagram of a partitioning result of a video frame according to an embodiment of this application.

FIG. 4 is a flowchart of another video coding method according to an embodiment of this application.

FIG. 5A is a schematic diagram of inclusion of a second coding unit (CU) in one first CU according to an embodiment of this application.

FIG. 5B is a schematic diagram of inclusion of a second CU in a plurality of first CUs according to an embodiment of this application.

FIG. 5C is a schematic flowchart of bitstream conversion according to an embodiment of this application.

FIG. 6 is a schematic structural diagram of a video coding apparatus according to an embodiment of this application.

FIG. 7 is a schematic structural diagram of a computer device according to an embodiment of this application.

### DESCRIPTION OF EMBODIMENTS

A brief introduction to related terms involved in this application is provided below.

High Efficiency Video Coding (HEVC): also known as H.265, it is an extension of Advance Video Coding (AVC, also known as H.264), and specifies a coding/decoding procedure and related syntax of bitstream data corresponding to H.265.

Versatile Video Coding (VVC): also known as H.266, it specifies a coding/decoding procedure and related syntax of bitstream data corresponding to H.266.

Coding unit (CU): it is a basic unit for coding a video frame. During coding, a CU may refer to an entire video frame (when the video frame is not partitioned), or may refer to a partial region in the video frame (when the video frame is partitioned).

Intra-frame prediction: it refers to the process in which a CU is coded without referring to information about other video frames in a video than a video frame to which the CU belongs.

Inter-frame prediction: it refers to the process in which a CU is coded by referring to information about a video frame in a video that is adjacent to a video frame to which the CU belongs.

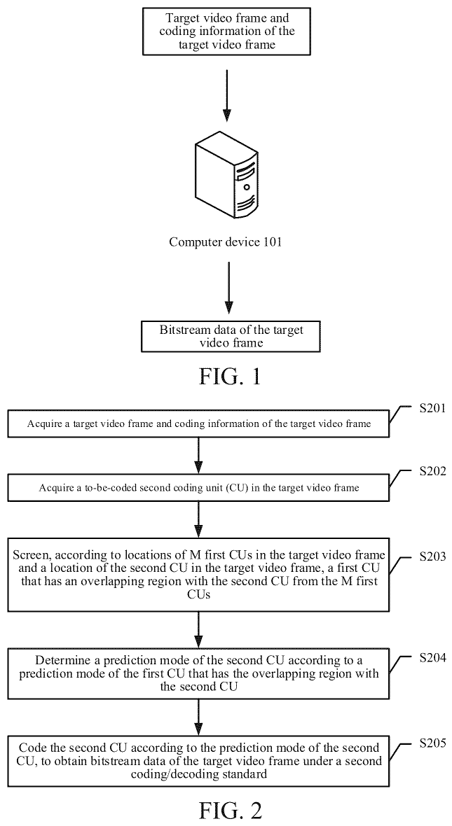

FIG. 1 is a schematic diagram of a scene of a video coding solution according to an embodiment of this application. As shown in FIG. 1, the video coding solution may be performed by a computer device 101, which may be a terminal device or a server. The terminal device includes, but is not limited to, an intelligent device such as a smartphone (such as an Android mobile phone or an iPhone operating system (iOS) mobile phone), a tablet computer, a portable personal computer, an intelligent appliance, an in-vehicle terminal, or a wearable device. This is not limited in the embodiments of this application. The server may be an independent physical server, or a server cluster or distributed system composed of a plurality of physical servers, or a cloud server providing basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. This is not limited in the embodiments of this application.

In addition, a quantity of computer devices is merely used as an example and does not constitute an actual limitation on this application. For example, a coding scene further includes a terminal device or a server. A target video frame and coding information of the target video frame may be transmitted to the computer device 101 by a computer device (such as a terminal device) other than the computer device 101, or may be obtained by decoding bitstream data by the computer device 101. The bitstream data is locally stored or obtained by coding the acquired target video frame according to a first coding/decoding standard. A source of the bitstream data is not limited in this application.

A general principle of the video coding solution is as follows:

(1) The computer device 101 acquires a target video frame and coding information of the target video frame. The target video frame includes M first CUs, and the M first CUs are obtained by partitioning the target video frame according to a first coding/decoding standard (such as HEVC). A specific partitioning mode may include any one of the following: no partitioning, horizontal bipartitioning, vertical bipartitioning, quadripartitioning, horizontal tripartitioning, and vertical tripartitioning. No partitioning means that the target video frame is not partitioned. Horizontal bipartitioning is a partitioning mode of partitioning the target video frame into two parts along a horizontal direction of the target video frame. Horizontal tripartitioning is a partitioning mode of partitioning the target video frame into three parts along the horizontal direction of the target video frame. Vertical bipartitioning is a partitioning mode of partitioning the target video frame into two parts along a vertical direction of the target video frame. Vertical tripartitioning is a partitioning mode of partitioning the target video frame into three parts along the vertical direction of the target video frame. Quadripartitioning is a partitioning mode of partitioning the target video frame into four parts along the horizontal direction and the vertical direction of the target video frame. The coding information of the target video frame includes locations of the M first CUs in the target video frame and prediction modes of the M first CUs under the first coding/decoding standard, and M is a positive integer. The location of each first CU in the target video frame may be indicated in a location indication mode such as coordinates or a combination of coordinates and side lengths. This is not limited in this application. The prediction mode may specifically include an inter-frame prediction mode and an intra-frame prediction mode.

In an implementation, the computer device 101 acquires bitstream data of the target video frame under the first coding/decoding standard, and decodes the bitstream data of the target video frame under the first coding/decoding standard according to a decoding standard corresponding to the first coding/decoding standard, to obtain the target video frame and the coding information of the target video frame.

(2) The computer device 101 acquires a to-be-coded second CU in the target video frame. The second CU is obtained by partitioning the target video frame according to a second coding/decoding standard (such as VVC), and the first coding/decoding standard is different from the second coding/decoding standard. In addition, in a specific implementation process, a partitioning result of partitioning the target video frame according to the first coding/decoding standard is identical to or different from a partitioning result of partitioning the target video frame according to the second coding/decoding standard.

In an implementation, the computer device 101 partitions the target video frame according to the second coding/decoding standard, to obtain one or more second CUs. The to-be-coded second CU may be any one of the one or more second CUs.

(3) The computer device 101 determines, according to the locations of the M first CUs in the target video frame and a location of the second CU in the target video frame, a first CU that has an overlapping region with the second CU from the M first CUs.

In an implementation, the locations of the first CU and the second CU are indicated by using vertex coordinates. The computer device 101 may determine regions, corresponding to the M first CUs and the second CU, in the target video frame according to coordinates of the first CU and the second CU, and determine, according to the regions, corresponding to the M first CUs and the second CU, in the target video frame, the first CU that has the overlapping region with the second CU from the M first CUs.

(4) The computer device 101 determines a prediction mode of the second CU according to the prediction mode of the first CU that has the overlapping region with the second CU.

In an implementation, the second CU is included in a j^{th} first CU, and j is a positive integer less than or equal to M. That is, the second CU only has an overlapping region with the j^{th} first CU. The computer device 101 sets the prediction mode of the second CU to the prediction mode of the j^{th} first CU.

In another implementation, the second CU is included in k first CUs, the prediction modes of the k first CUs are identical, and k is an integer greater than 1 and less than or equal to M. That is, the second CU has overlapping regions with at least two first CUs in the M first CUs. The computer device 101 sets the prediction mode of the second CU to the prediction mode of any one of the k first CUs.

In still another implementation, the second CU is included in k first CUs, the prediction modes of the k first CUs are different, and k is an integer greater than 1 and less than or equal to M. That is, the second CU has overlapping regions with at least two first CUs in the M first CUs. The computer device 101 determines the prediction mode of the second CU according to the prediction mode of at least one of the k first CUs.

(5) The computer device 101 codes the second CU according to the prediction mode of the second CU, to obtain bitstream data of the target video frame under the second coding/decoding standard. In an implementation, the target video frame is partitioned into one or more second CUs according to the second coding/decoding standard, and after acquiring the coding information of the target video frame, the computer device 101 determines a prediction mode of each second CU according to the method in operation (3) and operation (4), and codes each second CU according to the prediction mode of the second CU, to obtain the bitstream data of the target video frame under the second coding/decoding standard.

According to the embodiments of this application, the target video frame and the coding information of the target video frame are acquired, the target video frame includes the M first CUs, and the coding information includes the locations of the M first CUs in the target video frame and the prediction modes of the M first CUs. The to-be-coded second CU in the target video frame is acquired. The prediction mode of the second CU is determined according to the prediction mode of the first CU that is in the M first CUs and that has the overlapping region with the second CU. The second CU is coded according to the prediction mode of the second CU, to obtain the bitstream data of the target video frame under the second coding/decoding standard. It can be seen from the above that the prediction mode of the second CU is determined according to the prediction mode of the first CU that has the overlapping region with the second CU, whereby the process of determining the prediction mode of the second CU is greatly simplified, and coding efficiency of the video frame is improved.

Collection and processing of relevant data in the embodiments of this application need to strictly comply with the requirements of relevant laws and regulations. Acquisition of personal information need to be subject to the knowledge or consent of a personal subject (or the legal basis for acquiring the information), and subsequent use and processing of data is carried out within the scope of authorization of laws and regulations and the subject of the person information. For example, when the embodiments of this application are applied to a specific product or technology, such as acquisition of a video, permission or consent of a user who holds the video needs to be obtained, and collection, use, and processing of the relevant data need to comply with relevant laws, regulations, and standards of relevant regions.

Based on the foregoing video coding solution, the embodiments of this application provide a more detailed video coding method. The following describes the video coding method proposed in the embodiments of this application in detail with reference to the accompanying drawings.

FIG. 2 is a flowchart of a video coding method according to an embodiment of this application. The video coding method may be performed by a computer device, which may be a terminal device or a server. As shown in FIG. 2, the video coding method includes operation S201 to operation S205.

S201: Acquire a target video frame and coding information of the target video frame.

The target video frame may be any video frame in a to-be-converted video. The to-be-converted video may be understood as a video of which bitstream data obtained by coding according to a first coding/decoding standard (such as HEVC) needs to be converted into bitstream data obtained by coding according to a second coding/decoding standard (such as VVC).

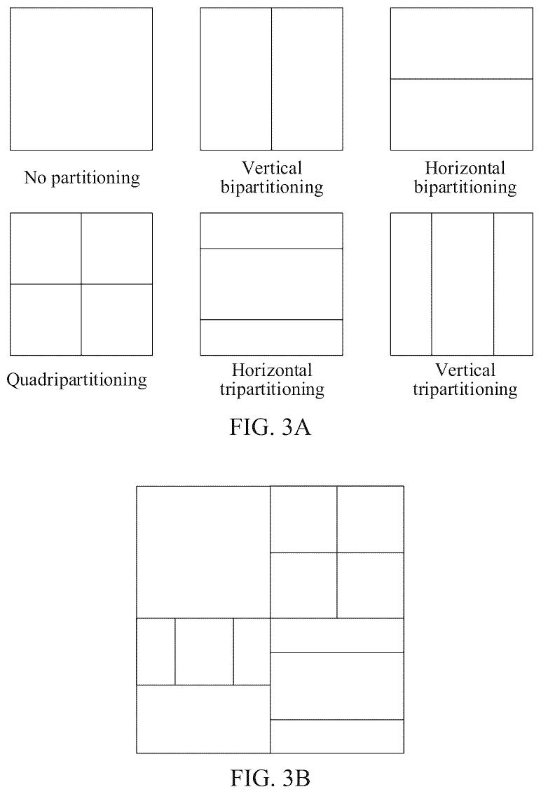

The target video frame includes M first CUs that are obtained by partitioning the target video frame according to the first coding/decoding standard, and M is a positive integer. FIG. 3A is a schematic diagram of a basic partitioning mode according to an embodiment of this application. As shown in FIG. 3A, the basic partitioning mode includes any one of the following: no partitioning, horizontal bipartitioning, vertical bipartitioning, quadripartitioning, horizontal tripartitioning, and vertical tripartitioning.

When the target video frame is partitioned according to the first coding/decoding standard, the foregoing 6 basic partitioning modes may be combined with each other, and a quantity of partitioning of the target video frame according to the first coding/decoding standard is not limited. For example, horizontal bipartitioning is first performed on the target video frame, to obtain an upper half of the target video frame and a lower half of the target video frame; and then, vertical tripartitioning is performed on the upper half of the target video frame, and the lower half of the target video frame is not further partitioned. FIG. 3B is a schematic diagram of a partitioning result of a video frame according to an embodiment of this application. As shown in FIG. 3B, quadripartitioning is first performed on the target video frame, to obtain an upper left quarter, an upper right quarter, a lower left quarter, and a lower right quarter of the target video frame; the upper left quarter of the target video frame is not further partitioned; quadripartitioning is further performed on the upper right quarter of the target video frame; horizontal bipartitioning is performed on the lower left quarter of the target video frame, vertical tripartitioning is performed on an upper half of the lower left quarter of the target video frame, and a lower half of the lower left quarter of the target video frame is not further partitioned; and horizontal tripartitioning is performed on the lower right quarter of the target video frame.

A prediction mode of each of the M first CUs may be an inter-frame prediction mode or an intra-frame prediction mode, which is specifically determined according to coding efficiency of the first CU in the two prediction modes.

In an implementation, the computer device acquires the bitstream data of the to-be-converted video under the first coding/decoding standard, and acquires bitstream data of the target video frame under the first coding/decoding standard from the bitstream data of the to-be-converted video under the first coding/decoding standard. The target video frame may be any video frame in the to-be-converted video. After acquiring the bitstream data of the target video frame under the first coding/decoding standard, the computer device may decode the bitstream data of the target video frame under the first coding/decoding standard according to a decoding standard corresponding to the first coding/decoding standard, to obtain the target video frame and the coding information of the target video frame.

S202: Acquire a to-be-coded second CU in the target video frame.

The second CU is obtained by partitioning the target video frame according to the second coding/decoding standard (such as VVC). In this application, the first coding/decoding standard is different from the second coding/decoding standard.

In an implementation, the computer device partitions a to-be-coded object according to P preset partitioning modes (for example, five other partitioning modes than no partitioning in FIG. 3A), to obtain P partitioning results of the to-be-coded object. The to-be-coded object may be the target video frame, or may be a target region (such as an upper half of the target video frame) in the target video frame, and P is a positive integer. If coding efficiency of the to-be-coded object under the P partitioning results is not higher than coding efficiency of the to-be-coded object (namely, coding efficiency when the to-be-coded object is not partitioned), the computer device may determine the to-be-coded object as the to-be-coded second CU in the target video frame. Correspondingly, if in the P partitioning results of the to-be-coded object, coding efficiency corresponding to a partitioning result is higher than the coding efficiency of the to-be-coded object (namely, the coding efficiency when the to-be-coded object is not partitioned), the computer device may further partition the to-be-coded object (in a partitioning mode corresponding to a partitioning result with the highest coding efficiency) until coding efficiency of a CU obtained through partitioning is the highest when the CU is not partitioned. It can be seen from the above that in the embodiments of this application, the target video frame is partitioned in the partitioning mode corresponding to the partitioning result with the highest coding efficiency, whereby coding efficiency of the CU obtained through partitioning is improved while the target video frame is partitioned.

In addition, in a specific implementation process, a basic partitioning mode in which the target video frame is partitioned according to the first coding/decoding standard is identical to a basic partitioning mode in which the target video frame is partitioned according to the second coding/decoding standard. For example, in the processes of partitioning the target video frame according to the first coding/decoding standard and partitioning the target video frame according to the second coding/decoding standard, the basic partitioning modes adopted by the computer device are the 6 basic partitioning modes shown in FIG. 3A. A result obtained by partitioning the target video frame according to the first coding/decoding standard may be identical to or different from a result obtained by partitioning the target video frame according to the second coding/decoding standard.

S203: Screen, according to the locations of the M first CUs in the target video frame and a location of the second CU in the target video frame, a first CU that has an overlapping region with the second CU from the M first CUs.

In an implementation, the locations of the first CU and the second CU are indicated by using vertex coordinates. The computer device may determine regions, corresponding to the M first CUs and the second CU, in the target video frame according to coordinates of the first CU and the second CU, and determine, according to the regions, corresponding to the M first CUs and the second CU, in the target video frame, the first CU that has the overlapping region with the second CU.

For example, it is assumed that upper left vertex coordinates of the second CU are (a0, b0), and lower right vertex coordinates of the second CU are (a1, b1); and upper left vertex coordinates of the first CU is (c0, d0), and lower right vertex coordinates of the first CU is (c1, d1). The case that the first CU has the overlapping region with the second CU needs to meet any one of the following conditions: b1<d0<b0 and a0<c0<a1; b1<d0<b0 and a0<c1<a1; b1<d1<b0 and a0<c0<a1; and b1<d1<b0 and a0<c1<a1.

S204: Determine a prediction mode of the second CU according to the prediction mode of the first CU that has the overlapping region with the second CU.

In an implementation, the second CU is included in a j^{th} first CU, and j is a positive integer less than or equal to M. That is, the second CU only has an overlapping region with the j^{th} first CU. The computer device sets the prediction mode of the second CU to the prediction mode of the j^{th} first CU.

In another implementation, the second CU is included in k first CUs, the prediction modes of the k first CUs are identical, and k is an integer greater than 1 and less than or equal to M. That is, the second CU has overlapping regions with at least two first CUs in the M first CUs. The computer device sets the prediction mode of the second CU to the prediction mode of any one of the k first CUs.

In still another implementation, the second CU is included in k first CUs, the prediction modes of the k first CUs are different, and k is an integer greater than 1 and less than or equal to M. That is, the second CU has overlapping regions with at least two first CUs in the M first CUs. The computer device determines the prediction mode of the second CU according to the prediction mode of at least one of the k first CUs.

S205: Code the second CU according to the prediction mode of the second CU, to obtain bitstream data of the target video frame under the second coding/decoding standard.

In an implementation, if the prediction mode of the second CU is intra-frame prediction, the computer device directly codes the second CU according to the second coding/decoding standard, to obtain a coding result of the second CU; or the computer device codes the second CU that is currently coded with reference to other second CUs (according to the second coding/decoding standard) in the target video frame than the second CU that is currently coded, to obtain a coding result of the second CU. After obtaining coding results of all second CUs included in the target video frame, the computer device obtains the bitstream data of the target video frame under the second coding/decoding standard based on the coding results of all second CUs included in the target video frame.

In another implementation, if the prediction mode of the second CU is inter-frame prediction, the computer device codes the second CU with reference to an adjacent frame (such as a second CU in the adjacent frame) of the target video frame, to obtain a coding result of the second CU. The adjacent frame of the target video frame refers to one or more frames that are in a video and that are played before or after the target video frame. After obtaining coding results of all second CUs included in the target video frame, the computer device obtains the bitstream data of the target video frame under the second coding/decoding standard based on the coding results of all second CUs included in the target video frame.

According to the embodiments of this application, the target video frame and the coding information of the target video frame are acquired, the target video frame includes the M first CUs, and the coding information includes the locations of the M first CUs in the target video frame and the prediction modes of the M first CUs. The to-be-coded second CU in the target video frame is further acquired. The prediction mode of the second CU is determined according to the prediction mode of the first CU that is in the M first CUs and that has the overlapping region with the second CU. By determining the prediction mode of the second CU according to the prediction mode of the first CU that has the overlapping region with the second CU, the process of determining the prediction mode of the second CU is greatly simplified, whereby a speed and efficiency of coding the second CU according to the prediction mode of the second CU are improved.

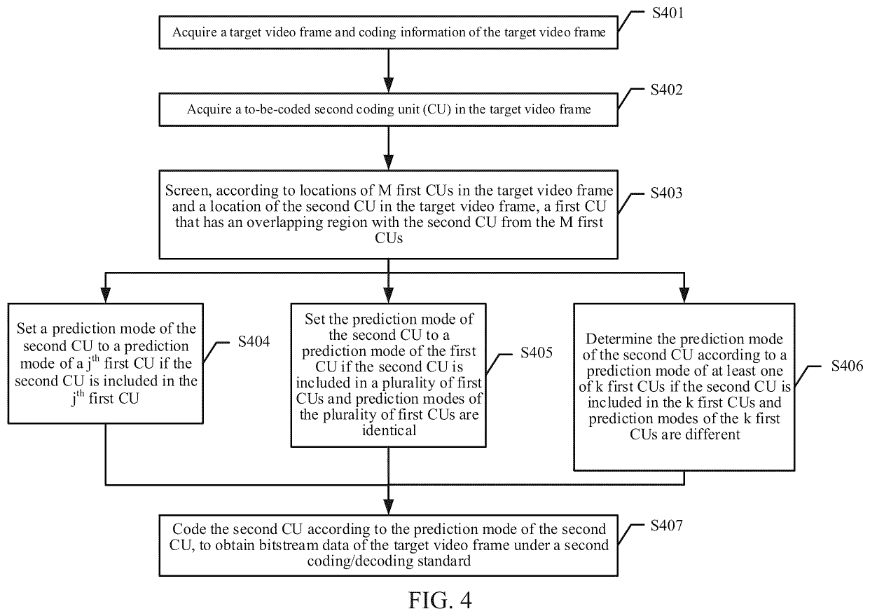

FIG. 4 is a flowchart of another video coding method according to an embodiment of this application. The video coding method may be performed by a computer device, which may be a terminal device or a server. As shown in FIG. 4, the video coding method includes operation S401 to operation S407.

S401: Acquire a target video frame and coding information of the target video frame.

S402: Acquire a to-be-coded second CU in the target video frame.

S403: Screen, according to locations of M first CUs in the target video frame and a location of the second CU in the target video frame, a first CU that has an overlapping region with the second CU from the M first CUs.

For specific implementations of operation S401 to operation S403, refer to the implementations of operation S201 to operation S203 in FIG. 2. Details are not described herein again.

S404: Set a prediction mode of the second CU to a prediction mode of a j^{th} first CU if the second CU is included in the j^{th} first CU.

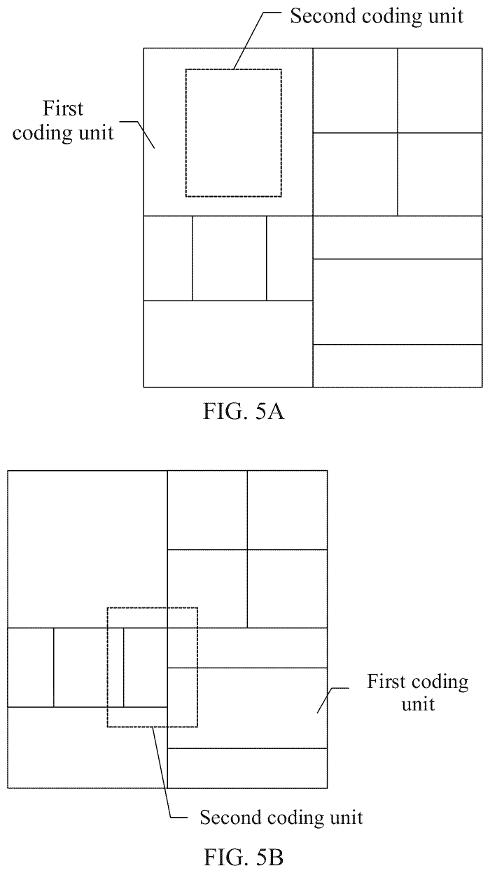

FIG. 5A is a schematic diagram of inclusion of a second CU in one first CU according to an embodiment of this application. As shown in FIG. 5A, when the second CU is included in one first CU, the second CU only has an overlapping region with one first CU. Specifically, that the second CU is included in the j^{th} first CU means that the second CU overlaps with the j^{th} first CU, or means that the second CU is located in the j^{th} first CU. j is a positive integer less than or equal to M.

In an implementation, it is assumed that upper left vertex coordinates of the second CU are (a0, b0), and lower right vertex coordinates of the second CU are (a1, b1); and upper left vertex coordinates of the j^{th} first CU are (c0, d0), and lower right vertex coordinates of the j^{th} first CU are (c1, d1). The case that the second CU is included in the j^{th} first CU needs to meet the following conditions: a0>c0, b0>d0, a1≤c1, and b1≤d1.

S405: Set the prediction mode of the second CU to a prediction mode of the first CU if the second CU is included in a plurality of first CUs and prediction modes of the plurality of first CUs are identical.

FIG. 5B is a schematic diagram of inclusion of a second CU in a plurality of first CUs according to an embodiment of this application. As shown in FIG. 5B, when the second CU is included in at least two first CUs, the second CU has overlapping regions with the plurality of (or at least two) first CUs.

In an implementation, the second CU is included in at least two first CUs, prediction modes of first CUs that have overlapping regions with the second CU are all identical, and the computer device sets the prediction mode of the second CU to the prediction mode of the first CU that has the overlapping region with the second CU.

S406: Determine the prediction mode of the second CU according to a prediction mode of at least one of k first CUs if the second CU is included in the k first CUs and prediction modes of the k first CUs are different, k being an integer greater than 1 and less than or equal to M.

In an implementation, the prediction mode includes an intra-frame prediction mode and an inter-frame prediction mode. The computer device collects statistics on a first quantity proportion of first CUs whose prediction modes are the intra-frame prediction modes in the k first CUs. The first quantity proportion is a ratio of a quantity of first CUs whose prediction modes are the intra-frame prediction modes in the k first CUs to k. If the first quantity proportion is greater than a quantity proportion threshold (such as 50% or 70%), the computer device determines the prediction mode of the second CU as the intra-frame prediction mode. In an embodiment, if the first quantity proportion is less than the quantity proportion threshold (such as 50%), the computer device determines the prediction mode of the second CU as the inter-frame prediction mode.

Similarly, the computer device may alternatively collect statistics on a second quantity proportion of first CUs whose prediction modes are the inter-frame prediction modes in the k first CUs. The second quantity proportion is a ratio of a quantity of first CUs whose prediction modes are the inter-frame prediction modes in the k first CUs to k. If the second quantity proportion is greater than the quantity proportion threshold (such as 50% or 70%), the computer device determines the prediction mode of the second CU as the inter-frame prediction mode. In an embodiment, if the second quantity proportion is less than the quantity proportion threshold (such as 50%), the computer device determines the prediction mode of the second CU as the intra-frame prediction mode. It can be seen from the above that by calculating the first quantity proportion or the second quantity proportion in the k first CUS, and taking the prediction mode corresponding to a quantity proportion (such as the first quantity proportion or the second quantity proportion) greater than a corresponding quantity proportion threshold as the prediction mode of the second CU, the prediction mode of the second CU is rapidly determined based on the prediction mode of the first CU is achieved, and accuracy of the prediction mode of the second CU is improved.

In an embodiment, the computer device collects statistics on the first quantity proportion of the first CUs whose prediction modes are the intra-frame prediction modes in the k first CUs, and collects statistics on the second quantity proportion of the first CUs whose prediction modes are the inter-frame prediction modes in the k first CUs; compares the first quantity proportion with the second quantity proportion if neither the first quantity proportion nor the second quantity proportion is greater than the quantity proportion threshold; determines the prediction mode of the second CU as the intra-frame prediction mode if the first quantity proportion is greater than the second quantity proportion; and determines the prediction mode of the second CU as the inter-frame prediction mode if the first quantity proportion is less than the second quantity proportion. If neither the first quantity proportion nor the second quantity proportion is greater than the quantity proportion threshold, the computer device may further randomly select one from the inter-frame prediction mode and the intra-frame prediction mode as the prediction mode of the second CU, or compare coding efficiency of the second CU in the inter-frame prediction mode with coding efficiency of the second CU in the intra-frame prediction mode, and determine a prediction mode with higher coding efficiency as the prediction mode of the second CU.

It can be seen from the above that by comparing the first quantity proportion with the second quantity proportion and taking a prediction mode corresponding to a larger quantity proportion as the prediction mode of the second CU, the prediction mode of the second CU can be rapidly determined, and accuracy of the prediction mode of the second CU can be improved. In addition, the prediction mode of the second CU may be determined according to coding efficiency of the second CU in different prediction modes, whereby the prediction mode of the second CU can be rapidly determined, and high coding efficiency of the second CU in the corresponding prediction mode can be ensured.

In another implementation, the prediction mode includes an intra-frame prediction mode and an inter-frame prediction mode. The computer device collects statistics on a first area proportion of a first CU whose prediction mode is the intra-frame prediction mode in the k first CUs. The first area proportion is a ratio of an overlapping area of the first CU whose prediction mode is the intra-frame prediction mode and the second CU to an area of the second CU. For example, it is assumed that the overlapping area of the first CU whose prediction mode is the intra-frame prediction mode and the second CU is 35, and the area of the second CU is 50, the first area proportion is 70%. If the first area proportion is greater than an area proportion threshold (such as 50% or 70%), the computer device determines the prediction mode of the second CU as the intra-frame prediction mode. In an embodiment, if the first area proportion is less than the area proportion threshold (such as 50%), the computer device determines the prediction mode of the second CU as the inter-frame prediction mode.

Similarly, the computer device may alternatively collect statistics on a second area proportion of a first CU whose prediction mode is the inter-frame prediction mode in the k first CUs. The second area proportion is a ratio of an overlapping area of the first CU whose prediction mode is the inter-frame prediction mode and the second CU to the area of the second CU. For example, it is assumed that the overlapping area of the first CU whose prediction mode is the inter-frame prediction mode and the second CU is 44, and the area of the second CU is 50, the second area proportion is 88%. If the second area proportion is greater than the area proportion threshold (such as 50% or 70%), the computer device determines the prediction mode of the second CU as the inter-frame prediction mode. In an embodiment, if the second area proportion is less than the area proportion threshold (such as 50%), the computer device determines the prediction mode of the second CU as the intra-frame prediction mode.

It can be seen from the above that by collecting statistics on area ratios of the overlapping areas of the first CUs with different prediction modes and the second CU to the area of the second CU and taking a prediction mode corresponding to a larger area ratio as the prediction mode of the second CU, the prediction mode of the second CU is rapidly determined, and accuracy of the prediction mode of the second CU is ensured.

In an embodiment, the computer device collects statistics on the first area proportion of the first CU whose prediction mode is the intra-frame prediction mode in the k first CUs, and collects statistics on the second area proportion of the first CU whose prediction mode is the inter-frame prediction mode in the k first CU; compares the first area proportion with the second area proportion if neither the first area proportion nor the second area proportion is greater than the area proportion threshold; determines the prediction mode of the second CU as the intra-frame prediction mode if the first area proportion is greater than the second area proportion; and determines the prediction mode of the second CU as the inter-frame prediction mode if the first area proportion is less than the second area proportion. If neither the first area proportion nor the second area proportion is greater than the area proportion threshold, the computer device may further randomly select one from the inter-frame prediction mode and the intra-frame prediction mode as the prediction mode of the second CU, or compare coding efficiency (or a distortion rate) of the second CU in the inter-frame prediction mode with coding efficiency (or a distortion rate) of the second CU in the intra-frame prediction mode, and determine a prediction mode with higher coding efficiency (or a distortion rate) as the prediction mode of the second CU.

It can be seen from the above that by comparing the first area proportion with the second area proportion and taking a prediction mode corresponding to a larger area proportion as the prediction mode of the second CU, the prediction mode of the second CU is rapidly determined, and accuracy of the prediction mode of the second CU is ensured. In addition, the prediction mode of the second CU may be determined according to coding efficiency of the second CU in different prediction modes, whereby coding efficiency of the second CU in the corresponding prediction mode is improved.

In still another implementation, the computer device randomly selects one first CU from the k first CUs; and sets the prediction mode of the second CU to a prediction mode of the selected first CU if an overlapping area of the selected first CU and the second CU is greater than an area threshold. The area threshold may be a fixed value, or may be calculated according to an area of the first CU. For example, the area threshold is 80% of a total area of a selected first CU. Correspondingly, if the overlapping area of the selected first CU and the second CU is less than or equal to the area threshold, the computer device continues to randomly select a first CU from other first CUs than the selected first CU until the prediction mode of the second CU is determined. If overlapping areas of the k first CUs and the second CU are all less than or equal to the area threshold, the prediction mode of the second CU is determined as a prediction mode of a first CU that is in the k first CUs and that has a largest overlapping area with the second CU.

In yet another implementation, the computer device acquires overlapping areas of the k first CUs and the second CU, and selects a first CU that meets an overlapping area selecting rule from the k first CUs. After selecting the first CU that meets the overlapping area selecting rule, the computer device determines the prediction mode of the second CU according to a prediction mode of the first CU that meets the overlapping area selecting rule. The first CU that meets the overlapping area selecting rule includes any one of the following: a first CU whose overlapping area is greater than an area threshold, a first CU whose overlapping proportion is greater than a proportion threshold, and a first CU whose overlapping area is greater than the area threshold and whose overlapping proportion is greater than the proportion threshold. The overlapping proportion refers to a ratio of an overlapping area of the first CU and the second CU to an area of the first CU. For example, it is assumed that the overlapping area of the first CU and the second CU is 37, and the area of the first CU is 50, the overlapping proportion of the first CU is 74%. If a quantity of first CUs that meet the overlapping area selecting rule is 1, the computer device may directly set the prediction mode of the second CU to the prediction mode of the first CU. If there are a plurality of (at least two) first CUs that meet the overlapping area selecting rule, the computer device may determine the prediction mode of the second CU by collecting statistics on quantity proportions or area proportions of the first CUs respectively corresponding to different prediction modes.

In another implementation, the computer device acquires location information (such as coordinates) of a first target point in each first CU and location information of a second target point in the second CU, and calculates a distance between the first target point (such as an upper left vertex, an upper right vertex, or a center point of the first CU) in each first CU and the second target point (such as an upper left vertex, an upper right vertex, or a center point of the second CU) of the second CU based on the acquired location information. After obtaining the distance between the first target point in each first CU and the second target point in the second CU, the computer device selects a first CU that meets a distance selecting rule from the k first CUs. The distance between the first target point in the first CU that meets the distance selecting rule and the second target point in the second CU is less than a distance threshold (for example, the distance is less than 10). The computer device determines the prediction mode of the second CU according to a prediction mode of the first CU that meets the distance selecting rule. If a quantity of first CUs that meet the distance selecting rule is 1, the computer device may directly set the prediction mode of the second CU to the prediction mode of the first CU. If there are a plurality of (at least two) first CUs that meet the distance selecting rule, the computer device may determine the prediction mode of the second CU by collecting statistics on quantity proportions or area proportions of the first CUs respectively corresponding to different prediction modes.

In still another implementation, if at least one of the k first CUs is included in the second CU, the computer device determines the prediction mode of the second CU according to a prediction mode of the at least one of the k first CUs. If a quantity of first CUs included in the second CU is 1, the computer device may directly set the prediction mode of the second CU to the prediction mode of the first CU. If there are a plurality of (at least two) first CUs included in the second CU, the computer device may determine the prediction mode of the second CU by collecting statistics on quantity proportions or area proportions of first the CUs respectively corresponding to different prediction modes.

S407: Code the second CU according to the prediction mode of the second CU, to obtain bitstream data of the target video frame under a second coding/decoding standard.

For a specific implementation of operation S407, refer to the implementation of operation S205 in FIG. 2. Details are not described herein again.

FIG. 5C is a schematic flowchart of bitstream conversion according to an embodiment of this application. As shown in FIG. 5C, during bitstream conversion, first bitstream data (bitstream data obtained by coding a video according to a first coding/decoding standard) is decoded (according to a decoding standard corresponding to the first coding/decoding standard) by using a decoder (such as an HEVC decoder), to obtain a decompressed video and coding information. After the decompressed video and the coding information are obtained, the decompressed video is coded by using a coder (such as a VVC coder) based on the coding information (according to a second coding/decoding standard), to obtain second bitstream data.

According to the embodiments of this application, the target video frame and the coding information of the target video frame are acquired, the target video frame includes the M first CUs, and the coding information includes the locations of the M first CUs in the target video frame and the prediction modes of the M first CUs. The to-be-coded second CU in the target video frame is further acquired. The prediction mode of the second CU is determined according to the prediction mode of the first CU that is in the M first CUs and that has the overlapping region with the second CU, whereby the process of determining the prediction mode of the second CU is greatly simplified, and coding efficiency of the target video frame is improved. For example, according to the quantity proportion (such as the first quantity proportion or the second quantity proportion), the prediction mode corresponding to the larger quantity proportion is set to the prediction mode of the second CU, whereby the prediction mode of the second CU is rapidly determined based on the prediction mode of the first CU, and an adaptation degree of the prediction mode determined for the second CU is improved. Then, the second CU is coded according to the prediction mode determined for the second CU, whereby more accurate bitstream data of the target video frame under the second coding/decoding standard can be obtained.

The method in the embodiments of this application is described in detail above. Correspondingly, an apparatus in the embodiments of this application is provided below to better implement the foregoing solutions in the embodiments of this application.

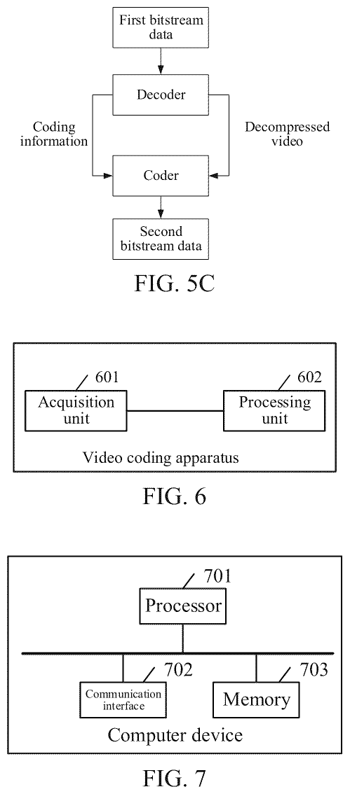

FIG. 6 is a schematic structural diagram of a video coding apparatus according to an embodiment of this application. The video coding apparatus shown in FIG. 6 may be mounted in a computer device, which may be specifically a terminal device or a server. The video coding apparatus may be configured to perform some or all of the functions in the method embodiments shown in FIG. 2 and FIG. 4. Refer to FIG. 6. The video coding apparatus includes:
an acquisition unit 601, configured to acquire a target video frame and coding information of the target video frame, the target video frame including M first CUs, and the M first CUs being obtained by partitioning the target video frame according to a first coding/decoding standard; and the coding information including locations of the M first CUs in the target video frame and prediction modes of the M first CUs under the first coding/decoding standard, and M being a positive integer; and
acquire a to-be-coded second CU in the target video frame, the second CU being obtained by partitioning the target video frame according to a second coding/decoding standard, and the second coding/decoding standard being different from the first coding/decoding standard; and
a processing unit 602, configured to select, according to the locations of the M first CUs in the target video frame and a location of the second CU in the target video frame, a first CU that has an overlapping region with the second CU;
determine a prediction mode of the second CU according to the prediction mode of the first CU that has the overlapping region with the second CU; and
code the second CU according to the prediction mode of the second CU, to obtain bitstream data of the target video frame under the second coding/decoding standard.

In an implementation, if the second CU is included in a j^{th} first CU, and j is a positive integer less than or equal to M; during determination of the prediction mode of the second CU according to the prediction mode of the first CU that has the overlapping region with the second CU, the processing unit 602 is specifically configured to:
set the prediction mode of the second CU to the prediction mode of the j^{th} first CU.

In an implementation, if the second CU is included in k first CUs, the prediction modes of the k first CUs are different, and k is an integer greater than 1 and less than or equal to M; during determination of the prediction mode of the second CU according to the prediction mode of the first CU that has the overlapping region with the second CU, the processing unit 602 is specifically configured to:
determine the prediction mode of the second CU according to the prediction mode of at least one of the k first CUs.

In an implementation, the prediction mode includes an intra-frame prediction mode and an inter-frame prediction mode; and during determination of the prediction mode of the second CU according to the prediction mode of at least one of the k first CUs, the processing unit 602 is specifically configured to:
collect statistics on a first quantity proportion of first CUs whose prediction modes are the intra-frame prediction modes in the k first CUs, and determine the prediction mode of the second CU as the intra-frame prediction mode if the first quantity proportion is greater than a quantity proportion threshold; or
collect statistics on a second quantity proportion of first CUs whose prediction modes are the inter-frame prediction modes in the k first CUs, and determine the prediction mode of the second CU as the inter-frame prediction mode if the second quantity proportion is greater than the quantity proportion threshold.

In an implementation, the prediction mode includes an intra-frame prediction mode and an inter-frame prediction mode; and during determination of the prediction mode of the second CU according to the prediction mode of at least one of the k first CUs, the processing unit 602 is specifically configured to:
collect statistics on a first area proportion of a first CU whose prediction mode is the intra-frame prediction mode in the k first CUs, and determine the prediction mode of the second CU as the intra-frame prediction mode if the first area proportion is greater than an area proportion threshold; or
collect statistics on a second area proportion of a first CU whose prediction mode is the inter-frame prediction mode in the k first CUs, and determine the prediction mode of the second CU as the inter-frame prediction mode if the second area proportion is greater than the area proportion threshold.

In an implementation, during determination of the prediction mode of the second CU according to the prediction mode of at least one of the k first CUS, the processing unit 602 is specifically configured to:
determine the prediction mode of the second CU according to the prediction mode of at least one of the k first CUs if the at least one of the k first CUs is included in the second CU.

In an implementation, during determination of the prediction mode of the second CU according to the prediction mode of at least one of the k first CUs, the processing unit 602 is specifically configured to:
randomly select one first CU from the k first CUs; and
set the prediction mode of the second CU to the prediction mode of the selected first CU if an overlapping area of the selected first CU and the second CU is greater than an area threshold.

In an implementation, during determination of the prediction mode of the second CU according to the prediction mode of at least one of the k first CUS, the processing unit 602 is specifically configured to:
acquire overlapping areas of the k first CUs and the second CU;
select a first CU that meets an overlapping area selecting rule from the k first CUs; and
determine the prediction mode of the second CU according to the prediction mode of the first CU that meets the overlapping area selecting rule.

The first CU that meets the overlapping area selecting rule includes any one of the following: a first CU whose overlapping area is greater than an area threshold, a first CU whose overlapping proportion is greater than a proportion threshold, and a first CU whose overlapping area is greater than the area threshold and whose overlapping proportion is greater than the proportion threshold.

In an implementation, during determination of the prediction mode of the second CU according to the prediction mode of at least one of the k first CUs, the processing unit 602 is specifically configured to:
acquire location information of a first target point in each of the k first CUs and location information of a second target point in the second CU;
calculate a distance between the first target point in each first CU and the second target point in the second CU according to the location information of the first target point in each first CU and the location information of the second target point in the second CU;
select a first CU that meets a distance selecting rule from the k first CUs, the distance between the first target point in the first CU that meets the distance selecting rule and the second target point being less than a distance threshold; and
determine the prediction mode of the second CU according to the prediction mode of the first CU that meets the distance selecting rule.

In an implementation, if the second CU is included in at least two first CUs, and the prediction modes of the at least two first CUs are identical; during determination of the prediction mode of the second CU according to the prediction mode of the first CU that has the overlapping region with the second CU, the processing unit 602 is specifically configured to:
set the prediction mode of the second CU to the prediction modes of the at least two first CUs.

In an implementation, during acquisition of the to-be-coded second CU in the target video frame, the processing unit 602 is specifically configured to:
partition a to-be-coded object according to P preset partitioning modes, to obtain P partitioning results of the to-be-coded object, the to-be-coded object being the target video frame or a target region in the target video frame, and P being a positive integer; and
determine the to-be-coded object as the to-be-coded second CU in the target video frame if coding efficiency of the to-be-coded object under the P partitioning results is not higher than coding efficiency of the to-be-coded object.

In an implementation, during acquisition of the target video frame and the coding information of the target video frame, the processing unit 602 is specifically configured to:
acquire bitstream data of the target video frame under the first coding/decoding standard; and
decode the bitstream data of the target video frame under the first coding/decoding standard, to obtain the target video frame and the coding information of the target video frame.

In an embodiment of this application, some operations in the video coding methods shown in FIG. 2 and FIG. 4 are performed by the units in the video coding apparatus shown in FIG. 6. For example, operation S201 and operation S202 shown in FIG. 2 are performed by the acquisition unit 601 shown in FIG. 6, and operation S203 to operation S205 are performed by the processing unit 602 shown in FIG. 6. Operation S401 and operation S402 shown in FIG. 4 are performed by the acquisition unit 601 shown in FIG. 6, and operation S403 to operation S407 are performed by the processing unit 602 shown in FIG. 6. The units in the video coding apparatus shown in FIG. 6 may be separately or completely combined into one or more other units, or one (or more) of the units may be further divided into a plurality of smaller functionally units, to implement same operations without affecting the technical effects of the embodiments of this application. The foregoing units are obtained through division based on logical functions. In an actual application, a function of one unit may be implemented by a plurality of units, or functions of a plurality of units may be implemented by one unit. In other embodiments of this application, the video coding apparatus also includes other units. In an actual application, the functions may alternatively be cooperatively implemented by other units and may be cooperatively implemented by a plurality of units.

In another embodiment of this application, the video coding apparatus shown in FIG. 6 is constructed and the video coding method in the embodiments of this application is implemented by running a computer program (including program code) that is configured to perform the operations in the corresponding methods shown in FIG. 2 and FIG. 4 on a general-purpose computing apparatus, such as a computer device, that includes a processing element and a storage element, such as a central processing unit (CPU), a random-access memory (RAM), and a read-only memory (ROM). The computer program may be recorded in, for example, a computer-readable recording medium, and may be loaded into the foregoing computing apparatus via the computer-readable recording medium and run in the computing apparatus.

Based on the same inventive concept, the problem-solving principle and beneficial effects of the video coding apparatus provided in the embodiments of this application are similar to those of the video coding method in the method embodiments of this application. Refer to the principle and beneficial effects of the implementation of the method. For brevity, details are not described herein again.

FIG. 7 is a schematic structural diagram of a computer device according to an embodiment of this application. The computer device may be a terminal device or a server. As shown in FIG. 7, the computer device at least includes a processor 701, a communication interface 702, and a memory 703. The processor 701, the communication interface 702, and the memory 703 may be connected via a bus or in another way. The processor 701 (or referred to as a CPU) is a computing core and a control core of the computer device, and may parse various instructions in the computer device and process various data of the computer device. For example, the CPU parses an on/off instruction transmitted by an object to the computer device, and controls the computer device to perform an on/off operation. For another example, the CPU transmits various types of interaction data between internal structures of the computer device. In an embodiment, the communication interface 702 includes a standard wired interface and a standard wireless interface (such as a Wireless Fidelity (Wi-Fi) interface or a mobile communication interface), and is configured to receive and transmit data under the control of the processor 701. The communication interface 702 may further be configured to transmit and exchange data inside the computer device. The memory 703 is a memory component in the computer device, and is configured to store a program and data. The memory 703 herein may include an internal memory of the computer device, and may also include an extended memory supported by the computer device. The memory 703 provides storage space for storing an operating system of the computer device, including but not limited to, Android and iOS, of the computer device. This is not limited in this application.

The embodiments of this application further provide a non-transitory computer-readable storage medium, which is a memory component in a computer device and is configured to store a program and data. The computer-readable storage medium herein may include an internal storage medium in the computer device, and may also include an extended storage medium supported by the computer device. The computer-readable storage medium provides storage space for storing an operating system of the computer device. Furthermore, a computer program suitable to be loaded and executed by a processor 701 is further stored in the storage space. In addition, the computer-readable storage medium herein may be a high-speed RAM, or may be a non-volatile memory, for example, at least one magnetic disk memory. In an embodiment, the computer-readable storage medium is at least one computer-readable computer storage that is located far away from the foregoing processor.

In an embodiment, the processor 701 performs the following operations by running the computer program in the memory 703:
acquiring a target video frame and coding information of the target video frame, the target video frame including M first CUs, and the M first CUs being obtained by partitioning the target video frame according to a first coding/decoding standard; and the coding information including locations of the M first CUs in the target video frame and prediction modes of the M first CUs under the first coding/decoding standard, and M being a positive integer;
acquiring a to-be-coded second CU in the target video frame, the second CU being obtained by partitioning the target video frame according to a second coding/decoding standard, and the second coding/decoding standard being different from the first coding/decoding standard;
selecting, according to the locations of the M first CUs in the target video frame and a location of the second CU in the target video frame, a first CU that has an overlapping region with the second CU from the M first CUs;
determining a prediction mode of the second CU according to the prediction mode of the first CU that has the overlapping region with the second CU; and
coding the second CU according to the prediction mode of the second CU, to obtain bitstream data of the target video frame under the second coding/decoding standard.

In an alternative embodiment, if the second CU is included in a j^{th} first CU, and j is a positive integer less than or equal to M; a specific embodiment of determining, by the processor 701, the prediction mode of the second CU according to the prediction mode of the first CU that has the overlapping region with the second CU is as follows:
the prediction mode of the second CU is set to the prediction mode of the j^{th} first CU.

In an alternative embodiment, if the second CU is included in k first CUs, the prediction modes of the k first CUs are different, and k is an integer greater than 1 and less than or equal to M; a specific embodiment of determining, by the processor 701, the prediction mode of the second CU according to the prediction mode of the first CU that has the overlapping region with the second CU is as follows:
the prediction mode of the second CU is determined according to the prediction mode of at least one of the k first CUs.

In an alternative embodiment, the prediction mode includes an intra-frame prediction mode and an inter-frame prediction mode; and a specific embodiment of determining, by the processor 701, the prediction mode of the second CU according to the prediction mode of at least one of the k first CUs is as follows:
statistics on a first quantity proportion of first CUs whose prediction modes are the intra-frame prediction modes in the k first CUs is collected, and the prediction mode of the second CU is determined as the intra-frame prediction mode if the first quantity proportion is greater than a quantity proportion threshold; or
statistics on a second quantity proportion of first CUs whose prediction modes are the inter-frame prediction modes in the k first CUs is collected, and the prediction mode of the second CU is determined as the inter-frame prediction mode if the second quantity proportion is greater than the quantity proportion threshold.

In an alternative embodiment, the prediction mode includes an intra-frame prediction mode and an inter-frame prediction mode; and a specific embodiment of determining, by the processor 701, the prediction mode of the second CU according to the prediction mode of at least one of the k first CUs is as follows:
statistics on a first area proportion of a first CU whose prediction mode is the intra-frame prediction mode in the k first CUs is collected, and the prediction mode of the second CU is determined as the intra-frame prediction mode if the first area proportion is greater than an area proportion threshold; or
statistics on a second area proportion of a first CU whose prediction mode is the inter-frame prediction mode in the k first CUs is collected, and the prediction mode of the second CU is determined as the inter-frame prediction mode if the second area proportion is greater than the area proportion threshold.

In an alternative embodiment, a specific embodiment of determining, by the processor 701, the prediction mode of the second CU according to the prediction mode of at least one of the k first CUs is as follows:
the prediction mode of the second CU is determined according to the prediction mode of at least one of the k first CUs if the at least one of the k first CUs is included in the second CU.

In an alternative embodiment, a specific embodiment of determining, by the processor 701, the prediction mode of the second CU according to the prediction mode of at least one of the k first CUs is as follows:
one first CU is randomly selected from the k first CUs; and
the prediction mode of the second CU is set to the prediction mode of the selected first CU if an overlapping area of the selected first CU and the second CU is greater than an area threshold.

In an alternative embodiment, a specific embodiment of determining, by the processor 701, the prediction mode of the second CU according to the prediction mode of at least one of the k first CUs is as follows:
overlapping areas of the k first CUs and the second CU are acquired;
a first CU that meets an overlapping area selecting rule is selected from the k first CUs; and
the prediction mode of the second CU is determined according to the prediction mode of the first CU that meets the overlapping area selecting rule.

The first CU that meets the overlapping area selecting rule includes any one of the following: a first CU whose overlapping area is greater than an area threshold, a first CU whose overlapping proportion is greater than a proportion threshold, and a first CU whose overlapping area is greater than the area threshold and whose overlapping proportion is greater than the proportion threshold.

In an alternative embodiment, a specific embodiment of determining, by the processor 701, the prediction mode of the second CU according to the prediction mode of at least one of the k first CUs is as follows:
location information of a first target point in each of the k first CUs and location information of a second target point in the second CU are acquired;
a distance between the first target point in each first CU and the second target point in the second CU is calculated according to the location information of the first target point in each first CU and the location information of the second target point in the second CU;
a first CU that meets a distance selecting rule is selected from the k first CUS, the distance between the first target point in the first CU that meets the distance selecting rule and the second target point being less than a distance threshold; and
the prediction mode of the second CU is determined according to the prediction mode of the first CU that meets the distance selecting rule.

In an alternative embodiment, if the second CU is included in at least two first CUs, and the prediction modes of the at least two first CUs are identical; a specific embodiment of determining, by the processor 701, the prediction mode of the second CU according to the prediction mode of the first CU that has the overlapping region with the second CU is as follows:
the prediction mode of the second CU is set to the prediction modes of the at least two first CUs.

In an alternative embodiment, a specific embodiment of acquiring, by the processor 701, the to-be-coded second CU in the target video frame is as follows:
a to-be-coded object is partitioned according to P preset partitioning modes, to obtain P partitioning results of the to-be-coded object, the to-be-coded object being the target video frame or a target region in the target video frame, and P being a positive integer; and
the to-be-coded object is determined as the to-be-coded second CU in the target video frame if coding efficiency of the to-be-coded object under the P partitioning results is not higher than coding efficiency of the to-be-coded object.

In an alternative embodiment, a specific embodiment of acquiring, by the processor 701, the target video frame and the coding information of the target video frame is as follows:
bitstream data of the target video frame under the first coding/decoding standard is acquired; and
the bitstream data of the target video frame under the first coding/decoding standard is decoded, to obtain the target video frame and the coding information of the target video frame.

Based on the same inventive concept, the problem-solving principle and beneficial effects of the computer device provided in the embodiments of this application are similar to those of the video coding method in the method embodiments of this application. Refer to the principle and beneficial effects of the implementation of the method. For brevity, details are not described herein again.

The embodiments of this application further provide a computer-readable storage medium, which has a computer program stored therein. A processor loads the computer program to perform the video coding method in the foregoing method embodiments.

The embodiments of this application further provide a computer program product or a computer program, which includes computer instructions. The computer instructions are stored in a computer-readable storage medium. A processor of a computer device reads the computer instructions from the computer-readable storage medium and executes the computer instructions, to cause the computer device to perform the foregoing video coding method.

The operations in the methods in the embodiments of this application may be adjusted in terms of a sequence, combined, and deleted according to an actual requirement.

The modules in the apparatuses in the embodiments of this application may be combined, divided, and deleted according to an actual requirement.

Those of ordinary skill in the art may understand that all or some operations in the methods in the foregoing embodiments may be performed by a program instructing related hardware. The program may be stored in a computer-readable storage medium, which may include: a flash drive, an ROM, an RAM, a magnetic disk, an optical disc, and the like.

The content disclosed above is merely exemplary embodiments of this application, but is not intended to limit the scope of the claims of this application. Those of ordinary skill in the art may understand all or a part of the procedures for implementing the foregoing embodiments, and equivalent variations made based on the claims of this application still fall within the scope of this application.

What is claimed is:

1. A video coding method performed by a computer device, the method comprising:
acquiring a target video frame and coding information of the target video frame, the target video frame comprising M first coding units (CUs) according to a first coding/decoding standard, and the coding information comprising locations of the M first CUs in the target video frame and prediction modes of the M first CUs under the first coding/decoding standard, and M being a positive integer;
acquiring a to-be-coded second CU in the target video frame according to a second coding/decoding standard, and the second coding/decoding standard being different from the first coding/decoding standard;
determining, according to the locations of the M first CUs in the target video frame and a location of the second CU in the target video frame, a first CU that has an overlapping region with the second CU;
determining a prediction mode of the second CU according to a prediction mode of the first CU; and
encoding the second CU according to the prediction mode of the second CU, to obtain bitstream data corresponding to the target video frame under the second coding/decoding standard.

2. The method according to claim 1, wherein the second CU is comprised in a j^{th} first CU, and j is a positive integer less than or equal to M, the determining a prediction mode of the second CU according to the prediction mode of the first CU that has the overlapping region with the second CU comprises:
setting the prediction mode of the second CU to the prediction mode of the j^{th} first CU.

3. The method according to claim 1, wherein the second CU is comprised in k first CUs, the prediction modes of the k first CUs are different, and k is an integer greater than 1 and less than or equal to M, the determining a prediction mode of the second CU according to the prediction mode of the first CU that has the overlapping region with the second CU comprises:
determining the prediction mode of the second CU according to the prediction mode of at least one of the k first CUs.

4. The method according to claim 3, wherein the prediction mode comprises an intra-frame prediction mode and an inter-frame prediction mode; and the determining the prediction mode of the second CU according to the prediction mode of at least one of the k first CUs comprises:
determining the prediction mode of the second CU as the intra-frame prediction mode when a first quantity proportion of first CUs whose prediction modes are the intra-frame prediction modes in the k first CUs is greater than a quantity proportion threshold; and
determining the prediction mode of the second CU as the inter-frame prediction mode when a second quantity proportion of first CUs whose prediction modes are the inter-frame prediction modes in the k first CUs is greater than the quantity proportion threshold.

5. The method according to claim 3, wherein the prediction mode comprises an intra-frame prediction mode and an inter-frame prediction mode; and the determining the prediction mode of the second CU according to the prediction mode of at least one of the k first CUs comprises:
determining the prediction mode of the second CU as the intra-frame prediction mode when a first area proportion of first CUs whose prediction modes are the intra-frame prediction modes in the k first CUs is greater than an area proportion threshold; and
determining the prediction mode of the second CU as the inter-frame prediction mode when a second area proportion of first CUs whose prediction modes are the inter-frame prediction modes in the k first CUs is greater than the area proportion threshold.

6. The method according to claim 3, wherein the determining the prediction mode of the second CU according to the prediction mode of at least one of the k first CUs comprises:
determining the prediction mode of the second CU according to the prediction mode of at least one of the k first CUs when the at least one of the k first CUs is comprised in the second CU.

7. The method according to claim 3, wherein the determining the prediction mode of the second CU according to the prediction mode of at least one of the k first CUs comprises:
randomly screening one first CU from the k first CUs; and
setting the prediction mode of the second CU to the prediction mode of the screened first CU when an overlapping area of the screened first CU and the second CU is greater than an area threshold.

8. The method according to claim 3, wherein the determining the prediction mode of the second CU according to the prediction mode of at least one of the k first CUs comprises:
acquiring overlapping areas of the k first CUs and the second CU;
screening a first CU that meets an overlapping area screening rule from the k first CUs; and
determining the prediction mode of the second CU according to the prediction mode of the first CU that meets the overlapping area screening rule; and
the first CU that meets the overlapping area screening rule comprises any one of the following: a first CU whose overlapping area is greater than an area threshold, a first CU whose overlapping proportion is greater than a proportion threshold, and a first CU whose overlapping area is greater than the area threshold and whose overlapping proportion is greater than the proportion threshold.

9. The method according to claim 3, wherein the determining the prediction mode of the second CU according to the prediction mode of at least one of the k first CUs comprises:
acquiring location information of a first target point in each of the k first CUs and location information of a second target point in the second CU;
calculating a distance between the first target point in each first CU and the second target point in the second CU according to the location information of the first target point in each first CU and the location information of the second target point in the second CU;
screening a first CU that meets a distance screening rule from the k first CUs, the distance between the first target point in the first CU that meets the distance screening rule and the second target point being less than a distance threshold; and
determining the prediction mode of the second CU according to the prediction mode of the first CU that meets the distance screening rule.

10. The method according to claim 1, wherein the second CU is comprised in at least two first CUs, and the prediction modes of the at least two first CUs are identical, the determining a prediction mode of the second CU according to the prediction mode of the first CU that has the overlapping region with the second CU comprises:
setting the prediction mode of the second CU to the prediction modes of the at least two first CUs.

11. The method according to claim 1, wherein the acquiring a target video frame and coding information of the target video frame comprises:
acquiring bitstream data corresponding to the target video frame under the first coding/decoding standard; and
decoding the bitstream data corresponding to the target video frame under the first coding/decoding standard, to obtain the target video frame and the coding information of the target video frame.

12. A computer device, comprising: a memory and a processor,
the memory having a computer program stored therein; and
the processor being configured to load the computer program to implement a video coding method including:
acquiring a target video frame and coding information of the target video frame, the target video frame comprising M first coding units (CUs) according to a first coding/decoding standard, and the coding information comprising locations of the M first CUs in the target video frame and prediction modes of the M first CUs under the first coding/decoding standard, and M being a positive integer;
acquiring a to-be-coded second CU in the target video frame according to a second coding/decoding standard, and the second coding/decoding standard being different from the first coding/decoding standard;
determining, according to the locations of the M first CUs in the target video frame and a location of the second CU in the target video frame, a first CU that has an overlapping region with the second CU;
determining a prediction mode of the second CU according to the prediction mode of the first CU that has the overlapping region with the second CU; and
encoding the second CU according to the prediction mode of the second CU, to obtain bitstream data corresponding to the target video frame under the second coding/decoding standard.

13. The computer device according to claim 12, wherein the second CU is comprised in a j^{th} first CU, and j is a positive integer less than or equal to M, the determining a prediction mode of the second CU according to the prediction mode of the first CU that has the overlapping region with the second CU comprises:
setting the prediction mode of the second CU to the prediction mode of the j^{th} first CU.

14. The computer device according to claim 12, wherein the second CU is comprised in k first CUs, the prediction modes of the k first CUs are different, and k is an integer greater than 1 and less than or equal to M, the determining a prediction mode of the second CU according to the prediction mode of the first CU that has the overlapping region with the second CU comprises:
determining the prediction mode of the second CU according to the prediction mode of at least one of the k first CUs.

15. The computer device according to claim 12, wherein the second CU is comprised in at least two first CUs, and the prediction modes of the at least two first CUs are identical, the determining a prediction mode of the second CU according to the prediction mode of the first CU that has the overlapping region with the second CU comprises:
setting the prediction mode of the second CU to the prediction modes of the at least two first CUs.

16. The computer device according to claim 12, wherein the acquiring a target video frame and coding information of the target video frame comprises:
acquiring bitstream data corresponding to the target video frame under the first coding/decoding standard; and
decoding the bitstream data corresponding to the target video frame under the first coding/decoding standard, to obtain the target video frame and the coding information of the target video frame.

17. A non-transitory computer-readable storage medium, having a computer program stored therein, the computer program, when executed by a processor of a computer device, causing the computer device to perform a video coding method including:
acquiring a target video frame and coding information of the target video frame, the target video frame comprising M first coding units (CUs) according to a first coding/decoding standard, and the coding information comprising locations of the M first CUs in the target video frame and prediction modes of the M first CUs under the first coding/decoding standard, and M being a positive integer;
acquiring a to-be-coded second CU in the target video frame according to a second coding/decoding standard, and the second coding/decoding standard being different from the first coding/decoding standard;
determining, according to the locations of the M first CUs in the target video frame and a location of the second CU in the target video frame, a first CU that has an overlapping region with the second CU;
determining a prediction mode of the second CU according to the prediction mode of the first CU that has the overlapping region with the second CU; and
coding the second CU according to the prediction mode of the second CU, to obtain bitstream data corresponding to the target video frame under the second coding/decoding standard.

18. The non-transitory computer-readable storage medium according to claim 17, wherein the second CU is comprised in a j^{th} first CU, and j is a positive integer less than or equal to M, the determining a prediction mode of the second CU according to the prediction mode of the first CU that has the overlapping region with the second CU comprises:
setting the prediction mode of the second CU to the prediction mode of the j^{th} first CU.

19. The non-transitory computer-readable storage medium according to claim 17, wherein the second CU is comprised in k first CUs, the prediction modes of the k first CUs are different, and k is an integer greater than 1 and less than or equal to M, the determining a prediction mode of the second CU according to the prediction mode of the first CU that has the overlapping region with the second CU comprises:
determining the prediction mode of the second CU according to the prediction mode of at least one of the k first CUs.

20. The non-transitory computer-readable storage medium according to claim 17, wherein the acquiring a target video frame and coding information of the target video frame comprises:
acquiring bitstream data corresponding to the target video frame under the first coding/decoding standard; and
decoding the bitstream data corresponding to the target video frame under the first coding/decoding standard, to obtain the target video frame and the coding information of the target video frame.
